(19) United States
(12) Patent Application Publication
(10) Pub. No.: US 2025/0292150 A1
(43) Pub. Date: Sep. 18, 2025

(54) SYSTEMS AND METHODS FOR BALANCED CLIENT SELECTION FOR DECENTRALIZED MACHINE LEARNING WITH NON-IID DATA

(71) Applicant: TOYOTA MOTOR ENGINEERING & MANUFACTURING NORTH AMERICA, INC., PLANO, TX (US)

(72) Inventors: CHIANING WANG, Mountain View, CA (US); Haoxiang Yu, Austin, TX (US); Alexander T. Pham, San Jose, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/606,730

(22) Filed: Mar. 15, 2024

(51) Int. Cl. G06N 20/00

(52) U.S. Cl. CPC G06N 20/00

(57) ABSTRACT

Systems and methods for implementing a balanced client selection for decentralized machine learning (BCS-DL) that can be utilized in both decentralized machine learning and hybrid machine learning for vehicle environments are described. For example, a vehicle can include a processor device training a machine learning model using local data, and a controller device performing balanced client selection in real-time to communicate the local machine learning model with a connected vehicle for decentralized machine learning. Hybrid machine learning combines aspects from federated learning and decentralized machine learning approaches. The disclosed BCS-DL system is designed to execute balanced client selection in real-time for vehicles that are acting as clients in a hybrid machine learning infrastructure. The balanced client selection also calculates a training contribution estimation (TCE) and a model weight computation (MWC) to mitigate imbalance in the data distribution incurred by non-Independent, Identically Distributed (non-IID data) related to decentralized and hybrid machine learning.

### TECHNICAL FIELD

The present disclosure relates to systems and methods for enabling real-time client selection in various decentralized machine learning environments, for example environments employing vehicles for machine learning.

### BACKGROUND

Machine learning is a subset of Artificial Intelligence (AI) that focuses on the development of algorithms and models that enable computers to learn and make predictions or decisions based on a collection of datasets. Instead of being explicitly programmed for a particular task, machine learning systems can use statistical patterns and inference to improve the performance over time as models are exposed to larger amounts of data.

Furthermore, as machine learning technology continues to grow and become more ubiquitous in real-world applications, the use of AI/ML similarly has expanded in the realm of automotives. For example, vehicles can use machine learning for various functions, such as autonomous driving, predictive maintenance, traffic prediction, and advanced driver assistance. It is possible for machine learning algorithms to analyze vehicle related data, including data from vehicle sensors, cameras, and other vehicle-based sources, which enable the vehicles to leverage machine learning in order to ultimately make real-time decisions to improve safety and efficiency on the road. To this end, there are machine learning infrastructures that have been developed that allow vehicles and other road-side devices to act as mobile clients that can be active participants in machine learning training. In many cases, the frameworks for these machine learning infrastructures are configured by utilizing a centralized approach. In a centralized machine learning infrastructure, the training process requires local data from a plurality of vehicles to be uploaded to a central server and often uses shared global machine learning models. Thus, centralized machine learning can experience several drawbacks, including high communication overhead, and a significantly large amount of infrastructure resources needed to support training, which in turn leads to high infrastructure costs. Therefore, it may be desirable to implement machine learning approaches in the automotive realm that enable vehicles to act as clients in a more distributed manner, and employing infrastructures that move away from the traditional and costly centralized systems to distributed frameworks.

### BRIEF SUMMARY OF EMBODIMENTS

According to various embodiments systems and methods implementing balanced client selection for decentralized machine learning with non-Independent, Identically Distributed (non-IID) data are disclosed herein. The disclosed examples include a system, such as a vehicle, including a processor device that trains a machine learning model using local data. The local machine learning model can be trained at the vehicle using a machine learning scheme. Additionally, the system includes a controller device that performs balanced client selection in real-time in order to communicate the local machine learning model with a connected vehicle for decentralized machine learning.

According to another embodiment, the disclosed examples include a method for performing balanced client selection in a decentralized machine learning process. The method involves performing training of a first local machine learning model at a first mobile client in accordance with a decentralized machine learning process. Training at the first mobile client further comprises calculating a class-wide data contribution estimation corresponding to locally training the first machine learning model at the first mobile client. Thereafter, the first mobile client aggregates the first machine learning model and a second machine learning model in accordance with a decentralized machine learning process. The aggregating comprises calculating a class-wide data contribution corresponding to aggregating the first machine learning model with the second machine learning model that was locally trained at a second mobile. The first mobile client can then update the first machine learning model based on the aggregating. The method can also execute one or more vehicle-related functions based on predictive inferences performed by the updated first machine learning client.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The technology disclosed herein, in accordance with one or more various implementations, is described in detail with reference to the following figures. The figures are provided for purposes of illustration only and merely depict typical or example implementations of the disclosed technology. These figures are provided to facilitate the reader's understanding of the disclosed technology and shall not be considered limiting of the breadth, scope, or applicability thereof. It should be noted that for clarity and ease of illustration these figures are not necessarily made to scale.

FIG. 1 is an example road environment including a decentralized machine learning infrastructure and a vehicle implementing a balanced client selection for decentralized machine learning (BCS-DL) system, in accordance with an embodiment of the technology disclosed herein.

FIG. 2 is an example road environment including a hybrid machine learning infrastructure and a vehicle implementing a BCS-DL system, in accordance with an embodiment of the technology disclosed herein.

FIG. 3 is a conceptual diagram of a method implementing balanced client selection for decentralized machine learning, in accordance with an embodiment of the technology disclosed herein.

FIG. 4 depicts an example network architecture of an in-vehicle BCS-DL system, in accordance with an embodiment of the technology disclosed herein.

FIG. 5 is a schematic representation of an example vehicle with which embodiments of the system disclosed herein may be implemented.

FIG. 6 is an example computing component that may be used to implement various features of embodiments described in the present disclosure.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

With the rapid advancement of computer networking technology, it has become more pervasive for a wide-range of devices with computational resources, including vehicles, to have the capability to generate and communicate large volumes of data. These large amounts of data from various devices, such as vehicles, can be utilized to obtain useful information that can be particularly leveraged for aspects of machine learning, including the training of machine learning models.

Particularly in the realm of vehicular-based computer technology, centralized machine learning may be applied and typically involves training machine learning models on a centralized server using data collected from a fleet of vehicles. Although vehicles are used for data collection in aspects of centralized machine learning, this data is ultimately sent to the central server which performs all of the model training. Centralized machine learning can be suitable for scenarios where there is a need for a unified model training on a comprehensive dataset, which allows for more efficient convergence of the machine learning models. However, due to limited network bandwidth associated with vehicular-based networks/connectivity and privacy concerns, it is usually impractical to transfer all the local data from many vehicles to a remote server for processing in a centralized manner. Furthermore, centralized machine learning does not allow any of the model training to be offloaded from the central server to be performed locally on individual vehicles. Thus, limiting vehicle environments to utilizing only centralized machine learning fails to leverage the powerful computational resources that many vehicles in the current market now have and, in turn, does not take advantage of the vast number of vehicles on the road that can be used for machine learning-based computations (e.g., model training, inference, etc.).

In the automotive realm, enabling vehicles to act as participating clients for machine learning in a more distributed manner and employing infrastructures that move away from the traditional and costly centralized systems to various distributed frameworks can be advantageous.

Federated learning and decentralized machine learning training are forms of distributed machine learning approaches that has recently attracted considerable attention over the traditional approach of centralized training, due to them enabling mobile clients (e.g., vehicles) to execute model training without the requirement of sharing local data (which may be privacy-sensitive data) to a central server. Particularly, federated learning allows multiple parties to collaboratively train a model without data sharing and gathering. Federated learning typically involves iteratively asking the participating nodes, which are also referred to as clients, to download a trained model from the server, train their own models based on their local data, and update the model parameters to the server, followed by letting the server aggregate the clients' updates to further improve the model. Thus, federated learning allows clients to collaboratively learn a shared model while keeping all the data on the local devices and ensures the safety of the data's privacy because data never leave the clients during the whole process.

Decentralized machine learning involves distributing the training process across multiple participating nodes, or clients, often without the involvement of a central server. Each client can independently perform the model training process and learn from its local data, and the models updates (or knowledge) are shared among the clients to collaboratively improve the overall model. Decentralized machine learning is beneficial as an approach in scenarios when data is distributed across various locations or devices, such as the case in many vehicle environments. Furthermore, because decentralized machine learning does not require the use of a centralized server, employing a decentralized framework can experience low communication overhead and low infrastructure costs (as compared to traditional centralized machine learning-based infrastructure).

Despite the great potential, a main challenge of the federated learning and decentralized learning approaches is that the training data is usually non-Independent, Identically Distributed (non-IID) on the clients. The presence of non-IID data in machine learning may bring associated biases in the model training and cause possible accuracy degradation. As referred to herein, non-IID data refers to data points that are not generated independently or do not come from the same underlying distribution. For instance, in cases where models are trained across decentralized clients, each client's local dataset may have a different data distribution which is not representative of the population distribution. Such an imbalance in the data distribution incurred by non-IID data will bring biases in the model training and may cause an accuracy degradation to federated and decentralized machine learning. Addressing the specific challenges that arise in machine learning related to non-IID data often requires specialized training and algorithms to account for the discrepancies and variations present in the data.

There are some additional limitations associated with the aforementioned federated learning and decentralized machine learning approaches. As an example, implementing federated learning in a vehicle environment would require a fixed infrastructure, for instance having a cloud server acting as a coordinator to facilitate communication and a federated learning model aggregation amongst vehicles. Accordingly, establishing infrastructure can be expensive (e.g., incorporating a hierarchy of vehicles, edge servers, and cloud servers) and would involve some communication overhead. On the other hand, decentralized learning approaches may suffer from inefficiencies or non-convergence due to the absence of a central controller, the dynamic nature of the environment, and unpredictable movement patterns associated with vehicles.

Embodiments of the present disclosure are directed to a balanced client selection for decentralized machine learning (BCS-DL) system that can be utilized in both a decentralized machine learning infrastructure and a hybrid machine learning infrastructure for vehicle environments. The hybrid machine learning infrastructure, as described herein, has a distinct framework that combines aspects from both federated learning and decentralized machine learning approaches. Hybrid machine learning infrastructure aims to achieve design tradeoffs between the two approaches, by integrating the strengths of both methods while minimizing their drawbacks. By integrating some aspects of decentralized machine learning (e.g., model training local the vehicles), a hybrid machine learning infrastructure can substantively reduce that amount of communication necessary with the server, leading to fewer servers being required, and decreased infrastructure costs. Conversely, by leveraging federated learning, the hybrid machine learning infrastructure can access more model information (e.g., model information from the central server), enhancing convergence speeds. The disclosed BCS-DL system is designed to execute balanced client selection in real-time for vehicles that are acting as clients in a hybrid machine learning infrastructure, and without losing the many advantages realized by implementing the sophisticated hybrid machine learning approach.

Furthermore, the BCS-DL system, as disclosed herein, implements a distinct balanced client selection technique that can overcome the challenges related to non-IID data (e.g., accuracy degradation) that may be experienced in decentralized and hybrid machine learning infrastructures. The balanced client selection technique tunes aspects of model training and model aggregation, which occurs locally at the vehicles, and thusly enables the vehicles to make decisions about model aggregation, weight allocation between models, and the necessity of aggregation, without the benefit of a comprehensive and global perspective (e.g., associated with centralized machine learning). Particularly, the balanced client selection technique calculates a training contribution estimation (TCE) which estimates a class-wide contribution derived from the training process, and a model weight computation (MWC) which computes the class-wide contribution resulting from model aggregation. Accordingly, the disclosed BCS-DL system can perform client selection in real-time whenever vehicles encounter other vehicles, and in a manner that has been optimized for distributed learning by mitigating non-convergence and training-related inaccuracies. Furthermore, the disclosed embodiments improve the overall training process and the performance of machine learning models in the aforementioned decentralized and hybrid frameworks that are often subjected to non-IID data at the clients.

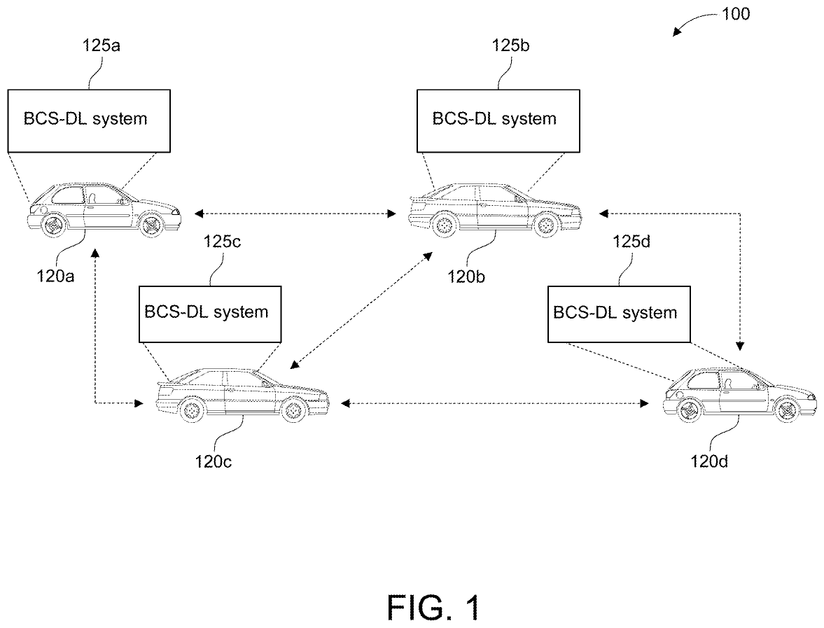

Referring now to FIG. 1, an example of a road environment 100 is depicted, which includes a plurality of vehicles 120A-120D that are each respectively configured to implement the BCS-DL systems 125A-125D and capabilities, as disclosed herein. FIG. 1 illustrates an example of a vehicle environment 100 that is particularly structured to implement a decentralized machine learning infrastructure. For example, the vehicles 120A-120D are configured with the communication and computational capabilities to implement decentralized machine learning, where machine learning can support several different vehicle-related functions such as autonomous driving, traffic prediction, predictive maintenance, fuel efficiency optimization, and advanced driver assistance.

FIG. 1 depicts that the vehicles 120A-120D can act as a client in the decentralized machine learning infrastructure, which enables each of the vehicles 120A-120D (or edge devices) to individually perform training of machine learning models, without sending data to a central server. For example, each of the vehicles 120A-120D can generate local data indicating the conditions of the current driving environment in real-time through use of its vehicle sensors, cameras, and other sources while operating on the road. Subsequently, each vehicle 120A-120D can independently perform local training using its local data.

The vehicles 120A-120D can respectively execute a localized training of its own local machine learning model using their locally generated data. According to the embodiments, the training process for machine learning models occurs locally at the individual vehicles 120A-120D in the decentralized infrastructure. After each of the vehicles 120A-120D have independently processed and learned from its local data, the vehicles 120A-120D can then share model updates amongst each other in order to collaboratively improve the overall model. For instance, periodically, model updates or information on how the model parameters should change (e.g., gradients) are exchanged between the vehicles 120A-120D. The exchange of model updates can occur directly between 120A-120D or through a decentralized network. As seen in FIG. 1, the vehicles 120A-120D are connected in a peer-to-peer mesh network. Subsequently, each of the vehicles 120A-120D can utilize information it has received from other vehicles to be aggregated with their local model as a collaborative learning process that is based on diverse data sources and ultimately improves their individual model.

Consequently, each vehicle 120A-120D (e.g., client) are involved in the decentralized machine learning process where models are individually processed and communicated with the other of vehicles 120A-120D to share information and improve the models. With this approach, machine learning is decentralized and distributed across a plurality of vehicles 120A-120D acting as clients (or nodes), and without the need for expensive infrastructure. According to the embodiments, each of the vehicles 120A-120D are respectively equipped with the BCS-DL system 125A-125D which is configured to execute various functions which support the aforementioned local training, model update exchanges, and model aggregation functions performed by the vehicles 120A-120D during decentralized machine learning.

As previously described, a prevalent challenge associated with distributed learning systems, including the decentralized learning infrastructure of FIG. 1, is the existence of non-independent and identically distributed (non-IID) data at the clients. In other words, the datasets at each of the vehicles 120A-120D may have non-IID data where the categories within the data are not uniformly distributed. As an example, vehicle 120A may have five images of an SUV and six images of a van in its local data, while the vehicle 120D has only one image of an SUV but 100 images of traffic lights in its local data. This non-IID distribution complicates model convergence, as the optimal point for each vehicle 120A-120D can vary significantly. For instance, clients with different degrees of non-IID data may present varying degrees of weight divergence with the clients having IID data. Accordingly, each of the BCS-DL systems 125A-125D are distinctly configured to enable the vehicles 120A-120D to execute a balanced client selection during real-time model update exchange (e.g., when encountering another vehicle) for decentralized machine learning. The BCS-DL systems 125A-125D can perform a selection from a set of candidate machine learning models without the benefit of a comprehensive and global perspective (e.g., federated learning), and in a manner that mitigates the accuracy degradation caused by non-IID data at the clients.

In traditional federated learning approaches for machine learning, the client selection can assume that a central aggregator (e.g., cloud server, edge server, etc.) maintains a comprehensive view of the entire system. This means, for federated learning, the central aggregator can perceive the landscape of the machine learning process and make informed decisions thereafter, which allows the central aggregator to then select from a set of candidate models judiciously. However, in the decentralized learning infrastructure of FIG. 1, there is an absence of such global information. The client selection has to happen in real-time, for instance when the vehicles 120A is in communicative proximity to vehicle 120B to be able to exchange local models for aggregation.

Continuing with the example, the BCS-DL system 125A of vehicle 120A can calculate a training contribution estimation (TCE) that is associated with its localized model, which estimates a class-wide contribution derived from its training process. Thus, the TCE provides a quantifiable awareness of the extent of information a model at vehicle 120A holds about a specific category. Again, referring back to the example, the TCE calculated for the local model of vehicle 120A by the BCS-DL system 125A will indicate that its model has information relating to data for observed SUVs and vans, but no information related to other categories of data, such as traffic lights, buses, trailers, and the like.

Additionally, the BCS-DL system 125A of vehicle 120A can determine a model weight computation (MWC) value which computes a class-wide contribution resulting from model aggregation. Thus, based on an exchanged model that vehicle 120A receives from vehicle 120B during its real-time model exchange (and any additional models it may receive from vehicles 120C, 120D) the BCS-DL system 125A can determine an appropriate aggregation weight (k) to assign to that model to achieve the best overall performance. For example, the MWC value calculated by the BCS-DL 125A can indicate that all of the information relating to traffic lights will be received from aggregating the exchange model from vehicle 120B.

Thus, by implementing a balanced client selection process that considers how much information each model contains for a particular category/type during both the local model training portion and model aggregation portion of the ML process, the BCS-DL system 125A can alleviate issues related to the biases in the model training often experienced due to the imbalanced data distribution in non-IID data. Due to the distinct capabilities of the BCS-DL systems 125A-125D, each of the vehicles 120A-120D can appropriately make decisions about model aggregation and weight allocation between models to achieve an accurate and efficiently converged ML process in decentralized machine learning, such as the infrastructure shown in FIG. 1, without a comprehensive/global perspective being required.

The systems and methods related to balanced client selection for decentralized machine learning, as disclosed herein, may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example of autonomous vehicles 120A-120D in which embodiments of the disclosed technology may be implemented is illustrated in FIG. 1. Although the example described with reference to FIG. 1 is a type of autonomous vehicle, the systems and methods described herein can be implemented in other types of vehicles including semi-autonomous vehicles, vehicles with automatic controls (e.g., dynamic cruise control), or other vehicles. Also, the example vehicles 120A-120D described with reference to FIG. 1 are a type of hybrid electric vehicle (HEV). However, this is not intended to be limiting, and the disclosed embodiments can be implemented in other types of vehicles including gasoline- or diesel-powered vehicles, fuel-cell vehicles, electric vehicles, or other vehicles.

According to an embodiment, vehicles 120A-120D can be autonomous vehicles that each are respectively implementing the BCS-DL systems 125A-125D and related functions, as disclosed herein. As used herein, “autonomous vehicle” means a vehicle that is configured to operate in an autonomous operational mode. “Autonomous operational mode” means that one or more computing systems of the vehicles 120A-120D are used to navigate and/or maneuver the vehicle along a travel route with a level of input from a human driver which varies with the operational mode. As such, 120A-120D can have a plurality of autonomous operational modes, where each mode correspondingly responds to a controller, for instance electronic control unit, with a varied level of automated response. In some embodiments, the vehicles 120A-120D can have an unmonitored autonomous operational mode. “Unmonitored autonomous operational mode” means that one or more computing systems are used to maneuver the vehicle along a travel route fully autonomously, requiring no input or supervision required from a human driver. Thus, as unmonitored autonomous vehicles 120A-120D, responses can be highly, or fully, automated. For example, a controller can be configured to communicate controls so as to operate the vehicle 120A autonomously and safely. After the controller communicates a control to the vehicle 120A operating as an autonomous vehicle, the vehicle 120A can automatically perform the desired adjustments (e.g., accelerating or decelerating) with no human driver interaction. Accordingly, the vehicles 120A-120D can operate any of the components shown in FIG. 1 autonomously, such as the engine.

Alternatively, or in addition to the above-described modes, the vehicle 120A-120D can have one or more semi-autonomous operational modes. “Semi-autonomous operational mode” means that a portion of the navigation and/or maneuvering of the vehicles 120A-120D along a travel route is performed by one or more computing systems, and a portion of the navigation and/or maneuvering of the vehicles 120A-120D along a travel route is performed by a human driver. One example of a semi-autonomous operational mode is when an adaptive cruise control system is activated. In such case, for example, the speed of a vehicle 120A can be automatically adjusted to maintain a safe distance from a vehicle ahead based on data received from on-board sensors, but the vehicle 120A is otherwise operated manually by a human driver. Upon receiving a driver input to alter the speed of the vehicle (e.g., by depressing the brake pedal to reduce the speed of the vehicle), the speed of the vehicle is reduced. Thus, with vehicles 120A-120D operating as a semi-autonomous vehicle, a response can be partially automated. In an example, the controller communicates a newly generated (or updated) control to the vehicle 120A operating as a semi-autonomous vehicle. The vehicle 120A can automatically perform some of the desired adjustments (e.g., accelerating) with no human driver interaction. Alternatively, the vehicle 120A may notify a driver that driver input is necessary or desired in response to a new (or updated) safety control. For instance, upon detecting a predicted trajectory that impacts safety, such as potential collision, vehicle 120A may reduce the speed to ensure that the driver is travelling cautiously. In response, vehicle 120A can present a notification in its dashboard display that reduced speed is recommended or required, because of the safety constraints. The notification allows time for the driver to press the brake pedal and decelerate the vehicle 120A to travel at a speed that is safe.

In some embodiments, the vehicles 120A-120D are also sensor-rich vehicles (SRVs) that are equipped with advanced vehicles sensors, described herein as ranging sensors (e.g., cameras, LIDAR, radar, ultrasonic sensors) and, in some cases, advanced computational resources. Accordingly, as SRVs, vehicles 120A-120D are enabled to utilize these advances sensors to sense various conditions on the roadway, and obtain data that is pertinent to traffic detection, such as, but not limited to: vehicle identifiers; the presence of other vehicles; vehicle position; vehicle speed; vehicle movement; vehicle motion direction; road data; lane data; vehicle acceleration; other static and dynamic objects; image data; planned route data; generated HD local map; processed perception data; and the like. The data from these sensors can be used as the local data at the vehicles 120A-120D that are to implement machine learning, as disclosed herein. For example, the various sensors of vehicles 120A-120D can obtain data that is used as datasets for executing the localized model training by the BCS-DL systems 125A-125D in decentralize machine learning, as disclosed herein.

Alternatively, the vehicles 120A-120D may be legacy vehicles that have some sensors that are capable of sensing and limited communication of more basic types of vehicle data, such as vehicle identifiers, vehicle location, vehicle speed, vehicle acceleration, and the like. For instance, a vehicle can be a legacy vehicle that includes Global Positioning System (GPS) sensors, which can provide the basic location, velocity, and acceleration of the vehicle.

Additionally, FIG. 1 depicts that the vehicles 120A-120D can have wireless communication capabilities. FIG. 1 illustrates a peer-to-peer mesh network, which establishes wireless connections between communicatively connected vehicles, shown in FIG. 1 as vehicles 120A-120D. For example, the vehicles 120A-120D can use wireless connectivity to communicate data for exchanging models and/or performing the balanced client selection techniques when vehicles are within the same vicinity (e.g., within wireless network range) on the roadway. Due to this wireless connectivity, data can be communicated between the connected vehicles, where the data can include information such as sensor messages, machine learning related data, machine learning models, balanced client selected related data (e.g., TCE values), maneuver messages, basic safety messages and the like. Sensor messages can include data collected by the vehicle sensors of SRVs and LVs, and other related data that may be obtained from sensors and/or devices on-board the vehicle. In some embodiments, sensor messages are implemented as a general class of wireless messages exchanged between road users and infrastructure that contains information about the objects detected in the surrounding environment. Examples could be the Sensor Data Sharing Messages standardized by SAE or the Collective Perception Messages standardized by ETSI.

As previously described, connected vehicles 120A-120D are configured to utilize types of wireless networking technology that are suitable for vehicles to form a peer-to-peer network in order to support the decentralized machine learning infrastructure depicted in FIG. 1. The wireless networking technology enables a vehicle to wirelessly communicate with other vehicles, infrastructure, and communication points. In the example of FIG. 1, vehicles 120A-120D are equipped with vehicle-to-vehicle (V2V) communication capabilities. Thus, vehicles 120A-120D can utilize the V2V communication capability to form a peer-to-peer communication (as the vehicles are within range for V2V-based wireless communication), and wirelessly exchange information, such as machine learning models, sensor data (e.g., speed and position of surrounding vehicles), and the like. That is, in the road environment 100 of FIG. 1, V2V enables at least a subset of the vehicles traveling within the same general section of the freeway (e.g., vehicles 120A-120D) to be able to communicate with each other. Vehicles 120A 120D can receive and analyze data that is communicated over the formed wireless communication network, and employ other vehicle components and/or systems, such as the BCS-DL system 125, to perform machine learning functions at the vehicles which ultimately support features such as autonomous driving and overall improves the road environment 100.

In some embodiments, the connected vehicles, namely vehicles 120A-120D, are configured to utilize other forms of wireless networking technology, such as vehicle-to-infrastructure (V2I) and/or vehicle-to-everything (V2X) capabilities in manner that supports other machine learning-based infrastructures as disclosed herein, including centralized, federated, and hybrid. Accordingly, vehicles 120A-120D can employ V2I and/or V2X communication to wireless exchange additional data between the vehicles and road infrastructure. Thus, in some cases, road environment 100 may include infrastructure components such as lane markings, road signs, and traffic lights which can wirelessly provide information to the vehicle, and vice versa. Consequently, the data communicated to/from connected vehicles can include additional data obtain from these infrastructure components in V2I and/or V2X communication, allowing the BCS-DL systems 125A-125D to have a vast amounts of real-time, information rich, data that is suitable for machine learning functions (e.g., training ML models). In some embodiments, the vehicles 120A-120D are further configured to employ the bidirectional communication of V2I and/or V2X to also provide the roadside units, cloud/edge servers, and traffic monitoring centers, with notifications of traffic congestion that it has detected and mitigative maneuvers (e.g., control actions) to be performed, when required and/or requested from the infrastructure.

Vehicles 120A-120D are each shown to include a respective BCS-DL system 125A-125D. The BCS-DL systems 125A-125D can be implemented as a vehicle controller, computing hardware, software, firmware, or a combination thereof, which is programmed to balanced client selection for decentralized machine learning in accordance with the disclosed techniques. The BCS-DL systems 125A-125D may be a standalone controller in some embodiments. Alternatively, the BCS-DL systems 125A-125D may be implemented by configuring a main vehicle onboard processor or CPU. As previously described, vehicles 120A-120D can obtain data from its vehicle sensors or the other communicatively connected vehicles, via wireless network connectivity. This data communicated from connected vehicles can be cooperatively fused and serve as input to the BCS-DL systems 125A-125D, in some cases, in order to perform machine learning functions that are distributed between the vehicles 120A-120D in a decentralized manner and realizes a wide-range of advantages, such as accuracy, efficient convergence, low communication overhead, and low infrastructure costs.

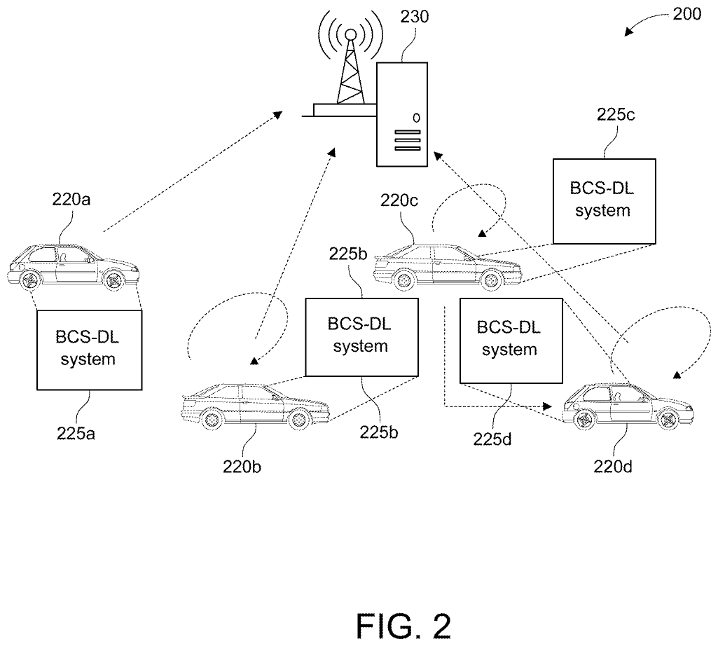

In FIG. 2, another example of a road environment 200 is depicted, which includes a plurality of vehicles 220A-220D, each having one of the BCS-DL systems 225A-225D implementing thereon, respectively. Particularly, FIG. 2 illustrates the vehicle environment 200 implementing a hybrid machine learning infrastructure, which integrates aspects of both federated machine learning and decentralized machine learning. As seen in FIG. 2, the infrastructure includes a coordinator, shown as a central server 230, which allows some beneficial components of federated machine learning to also be leveraged in the hybrid scheme. In some implementations, the central server 230 is an edge server that can also select the participating clients for a machine learning process within the vicinity of a vehicular network. FIG. 2 illustrates that some stages of the hybrid scheme involve federated machine learning, while decentralized machine learning, which was previously described in detail in reference to FIG. 1, is utilized for other stages of the hybrid process. For example, the hybrid scheme depicted in FIG. 2 can include a few of the clients, shown as vehicles 220A, 220B, and 220D, being in communication with the central server 230 and thus have the capability to upload their data to the central server 230 in accordance with federated machine learning. The central server 230 can then update a global machine learning model using the data gathered from these vehicles 220A, 220B, and 220D. Furthermore, some of the clients, depicted as vehicles 220B and 220D, can respectively use their local data to train a model locally (indicated in FIG. 2 with a curved arrow), and subsequently upload their locally trained model back to the central server 230.

Additionally, the hybrid scheme can include some decentralized stages, where the machine learning is performed in a distributed manner that is local to the client. FIG. 2 illustrates that some of the clients in the environment 200, shown as vehicle 220C, have the capability to individually train a local model without communicating with the central server 230, in accordance with decentralized machine learning. With executing decentralized machine learning, the vehicle 220C can perform localized model training (indicated in FIG. 2 with a dashed curved arrow), and then exchange its local model with vehicle 220D in real-time as vehicles 220C and 220D proximately encounter each other. Vehicles 220C, 220D employ their respective BCS-DL systems 225C, 225D in order to implement the balanced client selection technique, as disclosed herein, during this decentralized machine learning stage. As an example, the decentralized machine learning stage can involve the BCS-DL system 225C calculating a TCE value during the local model training process at vehicle 220C, which is then received during the model exchange with vehicle 220D. Subsequently, vehicle's 220C local model and TCE value can be analyzed by the BCS-DL system 225D to calculate a MDW value and perform a decentralized model aggregation at vehicle 220D. According to some embodiments, the balanced client selection technique involves dynamically selecting which clients are particularly selected to participate in a decentralized machine learning, and further for selecting which models are used for aggregation. FIG. 2 illustrates a configuration where each of the vehicles 220A-220D in the environment 200 are equipped with a respective BCS-DL system 225A-225D, such that each vehicle in the infrastructure has the capability to implement decentralized machine learning and the associated balance client selection features, as disclosed.

Thereafter, in the subsequent stages of federated learning when the central server 230 receives and aggregates the updates of the local models from vehicles 220B and 220D, the central server 230 also has information that has been contributed by the vehicle 220C in the decentralized machine learning stages. Accordingly, by leveraging decentralized machine learning at some clients (e.g., vehicle 220C) the hybrid infrastructure in FIG. 2 can lower computational costs, reduce the amount of communication that is required between other clients (e.g., vehicles 220B, 220D) and the central server 230 during federated machine learning. By lower communication overhead, the hybrid scheme of FIG. 2 can realize additional advantages such as requiring fewer centralized servers, decreasing infrastructure costs, reducing the load on the edge servers in the infrastructure, and increasing the overall system efficiency. Moreover, by continuing to utilize federated learning aspects, the hybrid scheme of FIG. 2 can further enhance convergence speeds (as compared to the decentralized machine learning scheme in FIG. 1) and becomes an overall more cost-to-performance efficient approach.

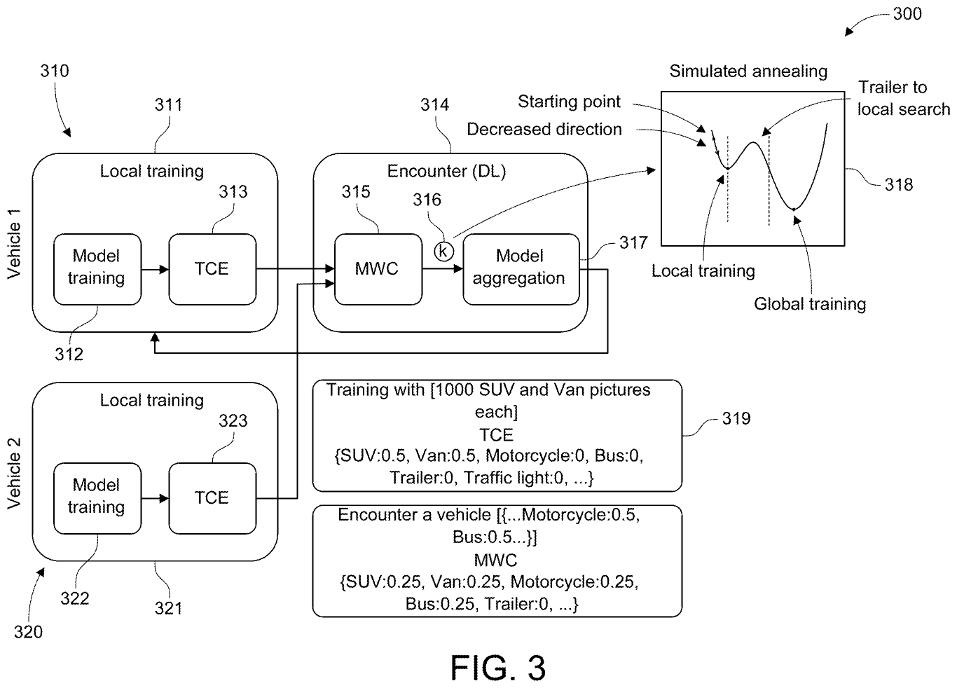

FIG. 3 is a conceptual diagram of a method 300 implementing balanced client selection for decentralized machine learning. In the example of FIG. 3, clients 310, 320 are participating in a decentralized and/or hybrid machine learning schemes, such as the vehicles implementing the BCS-DL system (shown in FIGS. 1-2). According to the embodiments, the balanced client selection method 300 is specifically applied to two stages of the machine learning process at the clients, including: 1) local model training; and 2) model aggregation, which occurs when vehicles encounter and exchange models. Particularly, the balanced client selection method 300 involves calculating a TCE value during the local model training stage, where the TCE estimates a class-wide contribution derived from the training during the local model training stage; and calculates a MWC value which computes the class-wide contribution resulting from model aggregation, during the model aggregation stage.

FIG. 3 depicts a first vehicle 310 executing a local training process 311, that involves a localized model training 312 (at the vehicle 310) which includes the calculation of its corresponding TCE 313; and a second vehicle 320 executing its local training process 321, that involves a localized model training 322 (at the vehicle 320) which includes the calculation of its corresponding TCE 323. The calculated TCEs 313, 323 can be a weight that represents the extent of information that a model holds about a specific category. In other words, this weight encapsulates the importance or influence a particular category exerts within the overall model.

The balanced client selection method 300 can employ two distinct algorithms, with the first algorithm is applied to the local model training stage of decentralized machine learning, and the second algorithm being applied during the model aggregation stage of decentralized machine learning. The first algorithm calculates the class-wide weight, which is represented mathematically as:

$${MW}_{1} [ {C}_{i} ] = max ( \frac{{MW}_{1} [ {C}_{i} ] * {Acc}_{after}}{{Acc}_{before}} , {MW}_{1} [ {C}_{i} ] + {min}_{c} ) ( {C}_{i} ∈ [ {C}_{x} , {C}_{y} , … , {C}_{z} ] ) \qquad ( 1 )$$

where Ci denotes the class related to this contribution, and
min_{c} is the minimum contribution constant.

The value for the TCE is a contribution that is calculated based on the percentage of accuracy improvement of the model, represented by ACC_{after} and ACC_{before} in eq(1). The constant min_{c} is employed to prevent a negative contribution, as training always provides some information to the model, even if the accuracy does not improve. Upon completion of eq(1), the model weight is normalized such that the sum of the weights equals 1.

FIG. 3 shows an example calculation 319, in a scenario where the vehicle 310 has a dataset that includes 1000 data samples (e.g., picture, image data, etc.) of “Vans” and 1000 data samples of “SUVs” that is used for training its local model during localized model training 312 (at the vehicle 310). The calculation 319 shows that deriving the TCE 313 involves normalizing values which represent how much information that the local model has about a particular category. The example calculation 319 depicts that the TCE 313 for the local model of vehicle 310 has a value of “0.5” for the “SUV” category, a value of “0.5” for the “Van” category, and value of “0” for the “motorcycle, bus, trailer, and traffic light” categories, indicating that its local model has “0.5” of its information related to SUVs, and “0.5” of its information related to SUVs and has no information related to the remaining categories of data (which were not included in the training dataset).

The second algorithm is applied during model aggregation, which occurs when the vehicles 310, 320 encounter each other and perform the balanced client selection method 300 to exchange models. In the second algorithm a value k is optimized to minimize the value which is represented mathematically as:

$$Min : sqrt ( \frac{\sum ( k * {MW}_{1} [ i ] + ( 1 - k ) * {MW}_{2} [ i ] )}{n} ) \qquad ( 2 )$$

The aim of this optimization in eq(2) is to reduce the standard distribution (sqrt) of the class-wide contribution weight. By utilizing this k value, the appropriate aggregation weight (k) can be determined to assign to each model to achieve the best overall performance (e.g., generalized performance). At the end of this algorithm, the model weight is again normalized. A generalized scenario for an optimization equation incorporating multiple models is represented mathematically as:

$$Min : sqrt ( \frac{\sum ( {k}_{1} * {MW}_{1} [ i ] + {k}_{2} * {MW}_{2} [ i ] ++ {k}_{j - 1} * {MW}_{j - 1} [ i ] + ( 1 - {k}_{1} - {k}_{2} - … - {k}_{j - 1} ) * {MW}_{j} [ i ] )}{n} ) \qquad ( 3 )$$

The primary objective of eq(3) is also to diminish the standard deviation of the class-wide contribution weight by determining the optimal values for k₁ through kⱼ₋₁. Given that the problem at hand is non-convex optimization, algorithms designed for convex optimization are unsuitable. Consequently, simulated annealing 318 can be applied as a strategy for identifying optimized values. Thus, simulated annealing 318 can yield the appropriate aggregation weight (k) to assign to each model to achieve the best overall performance from calculating the MWC 315.

Also, FIG. 3 depicts the first vehicle 310 executing an aggregation process 314, which can be executed when vehicles 310, 320 encounter each other (e.g., within communication range of each other) and exchange their respective local models. During the encounter with vehicle 320, vehicle 310 also receives the TCE 323 that was calculated with respect to vehicle's 320 local model. That is, vehicle 310 can automatically receive, from vehicle 320, its local model and TCE 323 during the encounter. As a result, vehicle 310 has both TCE 313 and TCE 323 that its used when calculating the MWC 315. It is the calculated MWC 315 that enables vehicle 310 to perform client selection in a manner that mitigates inaccuracies of non-IID data that may be experienced while aggregating the individually trained models.

In the example calculation 319, the MWC 315 is calculated after a local model for vehicle 320 is received for aggregation. The example calculation 319 shows that the local model for vehicle 320 has a TCE 323 that has a value of “0.5” for the “motorcycle” category, a value of “0.5” for the “Bus” category. Accordingly, after the local model from vehicle 320 is aggregated with the local model from vehicle 310, the resulting MWC 315 indicates that the aggregated model has “0.25” of its information related to Vans, and “0.25” of its information related to SUVs, “0.25” of its information related to motorcycles, and “0.25” of its information related to Buses. As alluded to above, the MWC 315 represents a weighted contribution of data from the local models of both vehicles 310, 320 to the overall aggregated model. Thus, the balanced client selection method 300 is distinctly implemented to compensate for imbalanced data distribution incurred by non-IID data (at vehicles 310, 320) in a manner that mitigates the biases in decentralized machine learning, and thereby increases the accuracy of the resulting machine learning models.

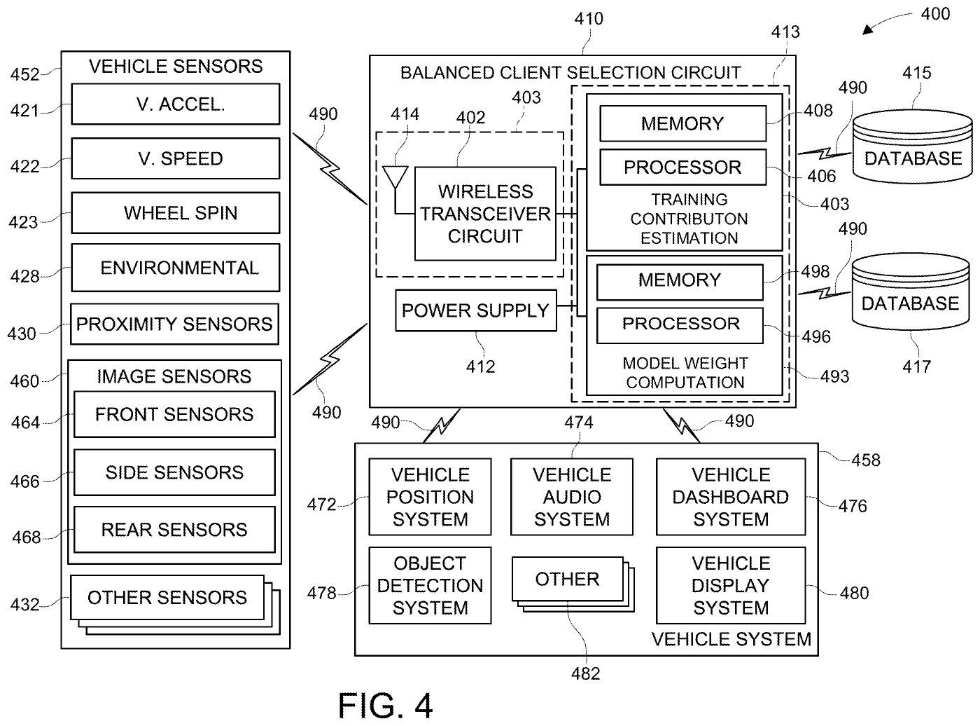

FIG. 4 illustrates an example of a balanced client selection for decentralized machine learning system in a vehicle 400 in accordance with one embodiment of the systems and methods described herein. The balanced client selection for decentralized machine learning system includes a balanced client selection circuit 410 communicatively connected to a plurality of sensors 452, a plurality of vehicle systems 458, a database 415 comprising roadway data, and a database 417 comprising balanced client selection rules. Sensors 452 and vehicle systems 458 wirelessly communicate with the balanced client selection circuit 410. Although in this example sensors 452 and vehicle systems 458 are depicted as communicating with balanced client selection circuit 410, they can also communicate with each other as well as with other vehicle systems. The balanced client selection circuit 410 can be implemented as an ECU or as part of an ECU. In other embodiments, the balanced client selection circuit 410 can be implemented independently of the ECU.

The balanced client selection circuit 410 in this example includes a communication circuit 401, a controller/CPU 413 comprising a training contribution estimation engine 403, and a model weight contribution engine 493, and a power suppl 412. Each engine includes a respective processor 406, 496 and respective memory 408, 496. For example, the training contribution estimation engine 403 includes a processor 406, and a memory 408 configured for performing the techniques involved in calculating a TCE value associated with the local model training stage of decentralized machine learning, as described herein; and the model weight contribution engine 493 includes a processor 496 and a memory 498 configured for performing the techniques involved in calculating the MWC value associated with the model aggregation stage of decentralized machine learning, as described herein.

Processor 406 can include one or more GPUs, CPUs, microprocessors, or any other suitable processing system. Processor 406 may include a single core or multicore processors. The memory 408 may include one or more various forms of memory or data storage (e.g., flash, RAM, etc.) that may be used to store instructions and variables for processor 406 as well as any other suitable information, such as, one or more of the following elements: rules data; resource data; GPS data; and base data, as described below. Memory 408 can be made up of one or more modules of one or more different types of memory, and may be configured to store data and other information as well as operational instructions that may be used by the processors 406 and 496.

Although the example of FIG. 4 is illustrated using processor and memory circuitry, as described below with reference to circuits disclosed herein, controller/CPU 413 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up the balanced client selection circuit 410. Communication circuit 401 includes either or both a wireless transceiver circuit 402 with an associated antenna 414 and a wired I/O interface with an associated hardwired data port (not illustrated). Communication circuit 401 can provide for V2X communications capabilities, allowing the balanced client selection circuit 410 to communicate with edge devices, such as roadside equipment (RSE), network cloud servers and cloud-based databases, and/or other vehicles.

As this example illustrates, communications with the balanced client selection circuit 410 can include either or both wired and wireless communications circuits 401. Wireless transceiver circuit 402 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 414 is coupled to wireless transceiver circuit 402 and is used by wireless transceiver circuit 402 to transmit radio signals wirelessly to wireless equipment with which it is connected and to receive radio signals as well. These RF signals can include information of almost any sort that is sent or received by the balanced client selection circuit 410 to/from other entities such as sensors 452 and vehicle systems 458.

Power supply 412 can include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, etc.), an energy harvester (e.g., solar cells, piezoelectric system, etc.), or it can include any other suitable power supply.

In the illustrated example, sensors 452 include vehicle acceleration sensors 421, vehicle speed sensors 422, wheelspin sensors 423 (e.g., one for each wheel), environmental sensors 428 (e.g., to detect salinity or other environmental conditions), proximity sensor 430 (e.g., sonar, radar, lidar or other vehicle proximity sensors), and image sensors 460. Additional sensors (i.e., other sensors 432) can be included as may be appropriate for a given implementation of the balanced client selection circuit 410.

The sensors 452 include front facing image sensors 464, side facing image sensors 466, and/or rear facing image sensors 468. Image sensors may capture information which may be used in detecting not only vehicle conditions but also detecting conditions external to vehicles 120A-120D (shown in FIG. 1) as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 460 can be used to, for example, to detect objects in an environment surrounding a vehicle 120, for example, traffic signs indicating a current speed limit, road curvature, obstacles, surrounding vehicles, and so on. For example, one or more image sensors 460 may capture images of neighboring vehicles in the surrounding environment. As another example, object detecting and recognition techniques may be used to detect objects and environmental conditions, such as, but not limited to, road conditions, surrounding vehicle behavior (e.g., driving behavior and the like), parking availability, etc. Additionally, sensors may estimate proximity between vehicles. For instance, the image sensors 460 may include cameras that may be used with and/or integrated with other proximity sensors 430 such as LIDAR sensors or any other sensors capable of capturing a distance. As used herein, a sensor set of a vehicle may refer to sensors 452 and image sensors 460 as a set.

Vehicle systems 458 include any of a number of different vehicle components or subsystems used to control or monitor various aspects of the vehicle and its performance. In this example, the vehicle systems 458 includes a vehicle positioning system 472; vehicle audio system 474 comprising one or more speakers configured to deliver audio throughout the vehicle; object detection system 478 to perform image processing such as object recognition and detection on images from image sensors 460, proximity estimation, for example, from image sensors 460 and/or proximity sensors, etc. for use in other vehicle systems; suspension system 480 such as, for example, an adjustable-height air suspension system, or an adjustable-damping suspension system; and other vehicle systems 482 (e.g., (e.g., Advanced Driver-Assistance Systems (ADAS), such as forward/rear collision detection and warning systems, pedestrian detection systems, autonomous or semi-autonomous driving systems, and the like).

The vehicle positioning system 472 includes a global positioning system (GPS). A vehicle 120 and the one or more connected vehicles may be DSRC-equipped vehicles. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

As used herein, the words “geographic location,” “location,” “geographic position” and “position” refer to a latitude and longitude of an object (or, a latitude, longitude, and elevation of an object), such as a connected vehicle, an RSE, a client device, etc. As used herein, the words “geographic area”, and “area,” refer to a physical space surrounding a location (e.g., an area of defined space surrounding a geographic location or geographic position). The example embodiments described herein may provide positioning information that describes a geographic position of a vehicle with an accuracy of one or more of: (1) at least plus or minus 1.5 meters in relation to the actual geographic position of the vehicle in two dimensions including a latitude and a longitude; and (2) at least plus or minus 3 meters in relation to the actual geographic position of the vehicle in an elevation dimension. Accordingly, the example embodiments described herein are able to describe the geographic position of the vehicle with lane-level accuracy or better.

Network 490 may be a conventional type of network, wired or wireless, and may have numerous different configurations including a star configuration, token ring configuration, or other configurations. Furthermore, the network 490 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 490 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 490 may include one or more IEEE 802.11 wireless networks.

In one embodiment, data comprising the location of vehicle is captured by the vehicle position system 458. The vehicle position system 458 can include one or more sensors 452 configured to capture vehicle position data. The vehicle positioning system 472 communicates with the balanced client selection circuit 410 to communicate and utilize actions at the vehicle 120 for various machine learning-based driving and/or maneuvering functions, including autonomous or semi-autonomous vehicle/driver safety features.

In an embodiment, the vehicle 120 produces notifications for the driver of the vehicle 120 using one or more notification methods. For example, the driver may receive a visual and/or audible notification that the vehicle may need to perform a maneuver to avoid an approaching unsafe driver, traffic incident, and/or traffic congestion, based on data and/or prediction that the balanced client selection circuit 410 has executed in accordance with the machine learning capabilities, as disclosed herein. In one embodiment, the notification methods include the vehicle systems 458 comprising the vehicle audio system 472 and the vehicle dashboard system 476. The notification methods include visual and/or audible methods of informing the driver of safety related issues. In one embodiment, the notification methods include notifying the driver of the ego vehicle 120 via one or more vehicle systems 458. For example, in one embodiment, the driver is notified of an unsafe driver via the vehicle audio system 474 (e.g., instructions played/broadcasted over one or more vehicle speakers), the vehicle display system 480 and/or the vehicle dashboard system 476. In one embodiment, the driver is notified of safety issues by a navigation system within the instrument cluster and the dashboard GUI. The notification can include visual instructions (e.g., visual directions on how to proceed), and/or auditory instructions (e.g., verbal commands from the vehicle sensing mechanism selection system to the driver).

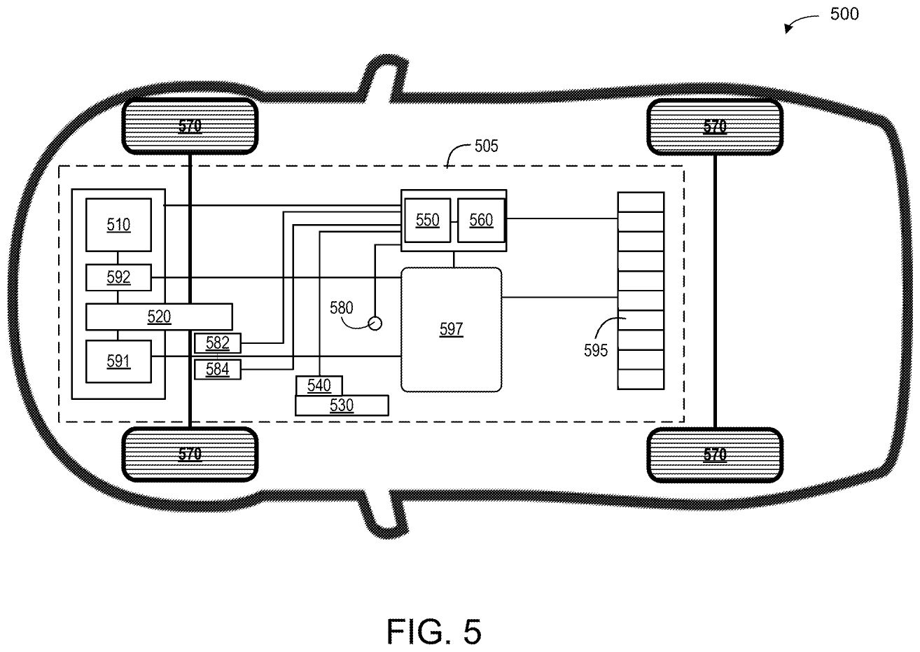

FIG. 5 illustrates an example hybrid electric vehicle (HEV) 500 in which various embodiments for the balanced client selection for decentralized machine learning system are implemented. For example, in one embodiment, the vehicle 120 (shown in FIG. 1) is a HEV 500. It should be understood that various embodiments disclosed herein may be applicable to/used in various vehicles (internal combustion engine (ICE) vehicles, fully electric vehicles (EVs), etc.) that are fully or partially autonomously controlled/operated, and not solely HEVs.

Here, HEV 500 includes drive force unit 505 and wheels 570. Drive force unit 505 includes an engine 510, motor generators (MGs) 591 and 592, a battery 595, an inverter 597, a brake pedal 530, a brake pedal sensor 540, a transmission 520, a memory 560, an electronic control unit (ECU) 550, a shifter 580, a speed sensor 582, and an accelerometer 584.

Engine 510 primarily drives the wheels 570. Engine 510 can be an ICE that combusts fuel, such as gasoline, ethanol, diesel, biofuel, or other types of fuels which are suitable for combustion. The torque output by engine 1410 is received by the transmission 520. MGs 591 and 592 can also output torque to the transmission 520. Engine 510 and MGs 591 and 592 may be coupled through a planetary gear (not shown in FIG. 4). The transmission 520 delivers an applied torque to the wheels 570. The torque output by engine 510 does not directly translate into the applied torque to the wheels 570.

MGs 591 and 592 can serve as motors which output torque in a drive mode, and can serve as generators to recharge the battery 595 in a regeneration mode. The electric power delivered from or to MGs 591 and 592 passes through inverter 597 to battery 595. Brake pedal sensor 540 can detect pressure applied to brake pedal 530, which may further affect the applied torque to wheels 570. Speed sensor 582 is connected to an output shaft of transmission 520 to detect a speed input which is converted into a vehicle speed by ECU 1450. Accelerometer 584 is connected to the body of HEV 500 to detect the actual deceleration of HEV 500, which corresponds to a deceleration torque.

Transmission 520 is a transmission suitable for an HEV. For example, transmission 520 can be an electronically controlled continuously variable transmission (ECVT), which is coupled to engine 510 as well as to MGs 591 and 592. Transmission 520 can deliver torque output from a combination of engine 510 and MGs 591 and 592. The ECU 550 controls the transmission 520, utilizing data stored in memory 560 to determine the applied torque delivered to the wheels 570. For example, ECU 550 may determine that at a certain vehicle speed, engine 510 should provide a fraction of the applied torque to the wheels while MG 491 provides most of the applied torque. ECU 550 and transmission 540 can control an engine speed (NE) of engine 540 independently of the vehicle speed (V).

ECU 540 may include circuitry to control the above aspects of vehicle operation. ECU 540 may include, for example, a microcomputer that includes a one or more processing units (e.g., microprocessors), memory storage (e.g., RAM, ROM, etc.), and I/O devices. ECU 540 may execute instructions stored in memory to control one or more electrical systems or subsystems in the vehicle. ECU 540 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 541 and 542 each may be a permanent magnet type synchronous motor including for example, a rotor with a permanent magnet embedded therein. MGs 541 and 542 may each be driven by an inverter controlled by a control signal from ECU 540 so as to convert direct current (DC) power from battery 545 to alternating current (AC) power, and supply the AC power to MGs 541, 542. MG 542 may be driven by electric power generated by motor generator MG 541. It should be understood that in embodiments where MG 541 and MG 542 are DC motors, no inverter is required. The inverter, in conjunction with a converter assembly may also accept power from one or more of MGs 541, 542 (e.g., during engine charging), convert this power from AC back to DC, and use this power to charge battery 495 (hence the name, motor generator). ECU 550 may control the inverter, adjust driving current supplied to MG 592, and adjust the current received from MG 591 during regenerative coasting and braking.

Battery 595 may be implemented as one or more batteries or other power storage devices including, for example, lead-acid batteries, lithium ion, and nickel batteries, capacitive storage devices, and so on. Battery 595 may also be charged by one or more of MGs 591, 592, such as, for example, by regenerative braking or by coasting during which one or more of MGs 591, 592 operates as generator. Alternatively (or additionally, battery 595 can be charged by MG 591, for example, when HEV 1400 is in idle (not moving/not in drive). Further still, battery 595 may be charged by a battery charger (not shown) that receives energy from engine 510. The battery charger may be switched or otherwise controlled to engage/disengage it with battery 595. For example, an alternator or generator may be coupled directly or indirectly to a drive shaft of engine 510 to generate an electrical current as a result of the operation of engine 510. Still other embodiments contemplate the use of one or more additional motor generators to power the rear wheels of a vehicle (e.g., in vehicles equipped with 4-Wheel Drive), or using two rear motor generators, each powering a rear wheel.

Battery 595 may also be used to power other electrical or electronic systems in the vehicle. Battery 595 can include, for example, one or more batteries, capacitive storage units, or other storage reservoirs suitable for storing electrical energy that can be used to power MG 591 and/or MG 592. When battery 595 is implemented using one or more batteries, the batteries can include, for example, nickel metal hydride batteries, lithium ion batteries, lead acid batteries, nickel cadmium batteries, lithium ion polymer batteries, and other types of batteries.

Where components are implemented in whole or in part using software, these software elements can be implemented to operate with a computing or processing component capable of carrying out the functionality described with respect thereto. One such example computing component is shown in FIG. 5. Various embodiments are described in terms of this example—computing component 500. After reading this description, it will become apparent to a person skilled in the relevant art how to implement the application using other computing components or architectures.

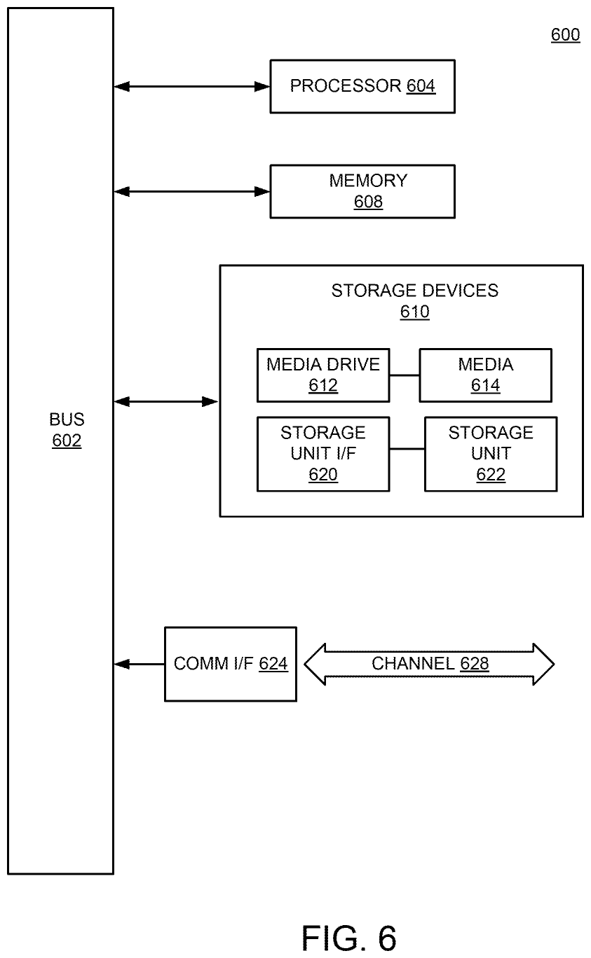

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor 604. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle, comprising:
a processor device training a machine learning model using local data, wherein the local machine learning model is trained at the vehicle using a machine learning scheme; and
a controller device performing balanced client selection in real-time to communicate the local machine learning model with a connected vehicle for decentralized machine learning.

2. The vehicle of claim 1, wherein the local data comprises non-independent and identically distribution data.

3. The vehicle of claim 1, wherein the controller device performs balanced client selection during the training of the machine learning model at the vehicle.

4. The vehicle of claim 3, wherein the balanced client selection performed during the training of the local machine learning model comprises calculating a class-wide contribution associated with the training of the local machine learning model.

5. The vehicle of claim 4, wherein the class-wide contribution associated with the training of the local machine learning model estimates a weight associated with a distribution incurred by the non-IID data during the training of the local machine learning model.

6. The vehicle of claim 3, wherein the controller further performs the device the balanced client selection in real-time to receive an additional local machine learning model from the connected vehicle for decentralized machine learning.

7. The vehicle of claim 2, wherein the controller further performs aggregating the additional local machine learning model from the connected vehicle with the local machine learning model trained at the vehicle.

8. The vehicle of claim 7, wherein the controller device performs the balanced client selection during the aggregation of the additional machine learning model at the vehicle.

9. The vehicle of claim 8, wherein the balanced client selection performed during the aggregation of the additional local machine learning model comprises calculating a class-wide contribution associated with the aggregation of the additional machine learning model at the vehicle.

10. The vehicle of claim 9, wherein the balanced client selection performed during the aggregation of the additional local machine learning model further comprises calculating an aggregation weight to assign to the local machine learning model and the additional local machine learning model to optimize performance.

11. The vehicle of claim 1, wherein the machine learning scheme used to train the local machine learning model comprises decentralized machine learning.

12. The vehicle of claim 1, wherein the machine learning scheme used to train the local machine learning model comprises federated machine learning.

13. The vehicle of claim 12, further comprises a communication device to connect to a hybrid machine learning infrastructure.

14. The vehicle of claim 13, wherein the hybrid machine learning infrastructure comprises a central server connected to the vehicle in accordance with federated machine learning.

15. The vehicle of claim 14, wherein training the local machine learning model using federated machine learning comprises communicating the local trained machine learning model to the central sever and receiving an aggregated machine learning model from the central server.

16. The vehicle of claim 15, wherein the aggregated machine learning model comprises a plurality of local machine learning models from a plurality of connected vehicles communicating with the central server in the hybrid machine learning infrastructure.

17. The vehicle of claim 11, wherein the additional local machine learning model is received from the connected vehicle via a vehicle-to-vehicle (V2V) communication.

18. The vehicle of claim 1, wherein the vehicle comprises an autonomous vehicle.

19. A method, comprising:
performing, at first a mobile client, training of a first local machine learning model in accordance with decentralized machine learning, wherein the training comprises calculating a class-wide data contribution estimation corresponding to locally training the first machine learning model at the first mobile client; aggregating, at the first mobile client, the first machine learning model and a second machine learning model in accordance with decentralized machine learning, wherein the aggregating comprises calculating a class-wide data contribution corresponding to aggregating the first machine learning model with the second machine learning model locally trained at a second mobile;
updating, at the first mobile client, the first machine learning model based on the aggregating; and
executing, at the first mobile client, one or more vehicle-related functions based on predictive inferences performed by the updated first machine learning client.

20. The method of claim 19, wherein the one or more vehicle-related functions comprises: autonomous driving, traffic prediction, predictive maintenance, fuel efficiency optimization, and advanced driver assistance.
